(19) United States
(12) Patent Application Publication
(10) Pub. No.: US 2013/0172470 A1
(43) Pub. Date: Jul. 4, 2013

(54) OPTIONALLY REINFORCED POLYAMIDE COMPOSITION CONTAINING IONOMER

(71) Applicant: E I Du Pont De Nemours and Company, Wilmington, DE (US)

(72) Inventors: Richard T. Chou, Hockessin, DE (US); Jennifer L. Thompson, Newark, DE (US); Herbert Vernon Bendler, Wilmington, DE (US)

(73) Assignee: E I DU PONT DE NEMOURS AND COMPANY, Wilmington, DE (US)

(21) Appl. No.: 13/713,023

(22) Filed: Dec. 13, 2012

Related U.S. Application Data
(60) Provisional application No. 61/582,183, filed on Dec. 30, 2011.

(51) Int. Cl. C08L 33/02

(52) U.S. Cl. CPC C08L 33/02
USPC 524/504; 524/502; 525/190; 525/77; 264/40.1

(57) ABSTRACT

Disclosed is a composition comprising a polyamide composition comprising nylon-66 or nylon 66/6T, and optionally nylon-6, nylon-610, nylon-612, nylon-11, nylon-12, an ionomer composition comprising at least one ethylene acid copolymer wherein 30 to 90% of the total acid functionalities are neutralized to salts with a mixture of zinc cations and sodium or lithium cations, wherein the salts comprise from 20 to 90% equivalents of zinc; and optionally reinforcing filler. Articles prepared from the composition exhibit improved calcium chloride salt stress crack resistance over polyamide compositions not containing the ionomer.

This application claims priority to U.S. Provisional Application No. 61/582,183, filed Dec. 30, 2011; the entire disclosure of which is incorporated herein by reference.

### FIELD OF THE INVENTION

The invention relates to a composition comprising polyamide, ionomer and optional filler reinforcements, and to articles prepared from the composition.

### DESCRIPTION OF PRIOR ART

Polyamides (nylons) are widely used in many industrial applications. Through modification, properties of polyamides can be tailored for the intended performance.

Taking advantage of the excellent mechanical properties, thermal resistance, toughness, lower cost, etc., nylon-66 based composites, including glass-reinforced nylon-66 composites, are used for components of automobile applications.

Automotive applications for polyamides also require resistance to metal salts, especially chloride salts.

Depending on the chemical nature of the polyamides, exposure to inorganic salt solutions has been known to cause stress cracking of polyamides (“salt stress cracking”, see “Stress Cracking of Nylon Polymers in Aqueous Salt Solutions Part 1 Stress-rupture behaviour,” M. G. Wyzgoski and G. E. Novak, Journal of Material Science, 1987, 1707-1714). Dunn and Sansom classified metal halides according to their ability to induce salt stress cracking (“The Stress Cracking of Polyamides by Metal Salts. Part 1. Metal Halides,” P. Dunn and G. F. Sansom, Journal of Applied Polymer Science, 1969, 13, 1641-1655). Zinc chloride was classified as a Type I salt, characterized as an extremely aggressive cracking agent for polyamides even at room temperature. Calcium chloride is milder in causing stress cracking and was classified as a Type II salt.

Polyamides with a higher ratio of methylene groups to amide (NHC═O), such as nylon-11 and nylon-12, are not susceptible to salt stress cracking when exposed to metal chloride salt solutions such as ZnCl₂ solution. On the other hand, polyamides with a lower ratio of methylene groups to amide, such as nylon-6 and nylon-66, are highly susceptible to cracking, with nylon-6 more susceptible than nylon-66 (“Stress Cracking of Nylon Polymers in Aqueous Salt Solutions Part 2 Nylon Salt interactions,” M. G. Wyzgoski and G. E. Novak, Journal of Material Science, 1987, 1715-1723).

Since nylon-66 is vulnerable to stress cracking caused by metal halides such as CaCl₂, the use of low cost nylon-66 compositions is limited for certain auto applications where the parts may be exposed to metal halides. Such parts include for example radiator end tanks.

Attempts to solve this problem have included blending nylon-66 with another polyamide having 6 to 11 methylene units per amide group such as nylon 610, nylon 612, nylon 11, nylon 12 (Japanese Patent JP1986040263). Similar blends with more defined viscosity and viscosity ratios are described in Japanese Patent JP1993001304. Japanese Patent Application Publication JP1983176246 describes similar blends further comprising ionomers, for example zinc ionomers. Japanese Patent Application Publication JP2003277604 describes similar glass-reinforced blends. The blends in these applications exhibited improved CaCl₂ stress cracking resistance, but polyamides with higher methylene/amide ratios are significantly more expensive than nylon-66.

U.S. Patent Application Publication 2011/0052848 discloses polyamides made from 1,6-hexanediamine, and the dicarboxylic acids 1,10-decanedioic acid, 1,12-dodecanedioic acid, or 1,14-tetradecanedioic acid and terephthalic acid in specified proportions that are particularly resistant to salt stressed (induced) corrosion cracking.

Accordingly, there is a need in industry to develop an alternate technology that enhances the stress cracking resistance of nylon 66 systems without using such expensive polyamides.

U.S. Pat. Nos. 4,745,143 and 4,801,633 disclose blends of polyamides with a water insoluble plasticizer and a zinc ionomer, with improved CaCl₂ stress cracking resistance, as determined by retention of elongation.

Ionomers are acid copolymers in which a portion of the carboxylic acid groups in the copolymer are neutralized to salts containing metal ions. U.S. Pat. No. 3,264,272 discloses a composition comprising a random copolymer of copolymerized units of an alpha-olefin having from two to ten carbon atoms, an alpha, beta-ethylenically-unsaturated carboxylic acid having from three to eight carbon atoms in which 10 to 90 percent of the acid groups are neutralized with metal ions, and an optional third mono-ethylenically unsaturated comonomer such as methyl methacrylate or ethyl acrylate.

It is known that thermoplastic blends based on ionomers and polyamides have a combination of desirable properties (see U.S. Pat. Nos. 4,174,358, 5,866,658, 6,399,684, 6,756,443 and 7,144,938). For example, U.S. Pat. No. 5,866,658 discloses a blend of an ionomer dispersed in a continuous or co-continuous polyimide phase in the range of 60/40 weight % to 40/60 weight % used for molded parts exhibiting toughness, high gloss, abrasion/scratch resistance, and high temperature properties. U.S. Pat. No. 6,399,684 discloses similar blends also containing phosphorous salts such as a hypophosphite salt.

The ionomers include zinc ionomers or ionomers with mixtures of zinc and magnesium cations, which have a neutralization of 65 to 100 mole percent of the acid groups. A higher degree of neutralization, however, may cause unacceptably high melt viscosity. To address the high melt viscosity of the blends of nylon and ionomer, one may use nylon of lower molecular weight and/or incorporate melt flow additives. For example, U.S. Pat. No. 6,756,443, “Ionomer/Polyamide Blends with Improved Flow and impact Properties”, discloses an ionomer/polyamide blend with improved flow (e.g., lower melt viscosity) by incorporating a low molecular weight ethylene/acrylic acid copolymer (acid wax). The method adds complexity and also inevitably compromises properties. U.S. Pat. No. 7,144,938 discloses similar blends also containing one or more esters of montanic acid.

U.S. Patent Application Publication 201010029819 discloses heat resistant polyamides that may optionally include Zn, Li, Mg or Mn ionomers as tougheners.

U.S. Patent Application Publications 2005/0203253A1, 2005/020762A1, and 2006/0142489A1 disclose polyamides toughened with ionomers of ethylene copolymers containing a monocarboxylic acid and a dicarboxylic acid or derivative thereof. U.S. Patent Application Publication 2011/0020573 discloses a blend comprising a polyamide, an ionomer of an ethylene copolymer containing a monocarboxylic acid and a dicarboxylic acid or derivative thereof, and a sulfonamide. Examples therein have excellent ZnCl₂ stress crack resistance, but also have high melt viscosity.

U.S. Patent Application Publication 2012/020940 discloses a blend comprising a polyamide, an ionomer of an ethylene copolymer containing a monocarboxylic acid and a dicarboxylic acid or derivative thereof, and a second ionomer.

U.S. Pat. No. 6,680,082 describes mixed ion ionomers, particularly ionomers with a mixture of zinc and magnesium, calcium, sodium or lithium for metal coating powder applications. U.S. Pat. No. 5,741,370 describes a mixture of sodium ionomer and zinc ionomer useful as a material for a solar module backskin. U.S. Patent Application Publication 2008/0097047 discloses blends of polyamides with ionomers, including blends with mixtures of zinc and sodium ionomers.

It is desirable to develop a glass-reinforced polyamide with high temperature resistance, high mechanical strength and excellent salt stress crack resistance. It is also desirable that such compositions make use of more readily available polyamides such as nylon-66 or nylon 66/6T.

### SUMMARY OF THE INVENTION

The invention relates to a composition or a blend comprising, consisting essentially of, consisting of, or produced from

(a) about 60 to about 80 weight % of polyamide composition comprising nylon-66, nylon-6/66 or nylon 66/6T, and optionally up to 40 weight %, based on the total polyamide composition, of nylon-6, nylon-610, nylon-612, nylon-11, nylon-12 or mixtures thereof;

(b) about 20 to about 40 weight %, preferably about 25 to about 40 weight %, of an ionomer composition, wherein the ionomer composition comprises at least one copolymer comprising copolymerized units of ethylene, 3 to 20 weight % of copolymerized units of at least one α,β-unsaturated C₃-C₈ monocarboxylic acid and 0 to 30 weight % of copolymerized units of alkyl acrylate or alkyl methacrylate; and 30 to 90% of the total monocarboxylic acid functionalities are neutralized to salts with a mixture of zinc cations and sodium or lithium cations; and optionally

(c) reinforcing filler (such as glass fiber) in the range of about 0.1 to about 50 weight % of the total weight of (a), (b) and (c).

The invention also provides shaped articles comprising the composition.

Articles prepared from the composition have excellent salt stress crack resistance. As used herein, excellent salt stress crack resistance indicates that standard test plaques exposed to 50% aqueous calcium chloride solution at about 80 or about 90° C. exhibit no cracks when tested according to ASTM D1693.

Accordingly, the invention also provides a method for improving the salt stress crack behavior of an article comprising a polyamide composition, comprising

(a) providing a polyamide composition comprising nylon-66, nylon-6/66 or nylon 66/6T, and optionally up to 40 weight %, based on the total polyamide component, of nylon-6 (poly(ε-caprolactam)), nylon-610, nylon-612, nylon-11, nylon-12 or mixtures thereof;

(b) melt blending the polyamide with an ionomer comprising at least one copolymer comprising copolymerized comonomners of ethylene, 3 to 20 weight % of at least one α,β-unsaturated C₃-C₈ monocarboxylic acid, and 0 to 30 weight % of alkyl acrylate or alkyl methacrylate; and 30 to 90% of the total carboxylic acid functionalities are neutralized to salts with a mixture of zinc cations and sodium or lithium cations, wherein the salts comprise from 20 to 90% equivalents of zinc; to provide a molten blend composition comprising about 60 to about 80 weight % of the polyamide and about 20 to about 40 weight % of the ionomer;

(c) optionally blending in reinforcing filler, such as glass fiber, in the range of about 0.1 to about 50 weight % of the total weight of the composition;

(d) shaping the molten blend composition into a defined shape;

(e) allowing the shaped molten blend composition to cool, thereby providing a shaped article;

wherein the salt stress crack behavior of the blend composition when tested according to ASTM D1693 is characterized by standard test plaques that exhibit fewer cracks than comparison test plaques prepared from a similar composition that does not contain the ionomer when exposed to 50% aqueous calcium chloride solution at about 80° C. for at least 24 hours.

### DETAILED DESCRIPTION OF THE INVENTION

All references disclosed herein are incorporated by reference.

Unless stated otherwise, all percentages, parts and ratios, are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range having a lower limit of 0, such component is an optional component (i.e., it may or may not be present). Such optional components, when present, are included in an amount preferably of at least about 0.1 weight % of the total weight of the composition or polymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of acrylic acid”. Such a description may be considered informal in that it does not refer to the comonomers as copolymerized units; however, a description of a copolymer with reference to its constituent comonomers or to the amounts of its constituent comonomers means that the copolymer contains copolymerized units (in the specified amounts when specified) of the specified comonomers.

For polyamides, the term copolymer refers to polyamides that have two or more amide and/or diamide molecular repeat units.

“Sheets” and “films” may be used interchangeably to describe articles wherein the compositions are processed into generally planar forms, either monolayer or multilayer. The processing method and/or the thickness may influence whether the term “sheet” or “film” is used herein, but either term can be used to describe such generally planar articles.

By a “vehicle” is meant any device that moves and transports people and/or freight or performs other functions. The vehicle may be self propelled or not, and may typically move on wheels, tracks, skids and/or runners. Applicable vehicles include automobiles, motorcycles, wheeled construction vehicles, farm or lawn tractors, trucks, trailers, all-terrain vehicles, snowmobiles and the like. Notable vehicles are automobiles, trucks, and motorcycles.

The compositions described herein provide vehicular parts with improved resistance to degradation due to exposure to salt. Such exposure may be typically encountered, for instance, by parts that come into contact with road salt or salt in and around oceans and other bodies of water. In normal operation in these environments vehicular parts, particularly those used in under-the-hood applications, are vulnerable to degradation over prolonged periods of time. Even intermittent exposure to salt over time can have adverse effects.

“In normal operation said part is exposed to salt” means that when tested in a normal vehicle configuration (as supplied by the manufacturer with all OEM guards in place, but no additional equipment present), the part is wet or otherwise exposed to a water solution on its exposed side in the following test. The vehicle is driven (or towed if not self propelling) at 50 km/h (about 30 mph) for 20 meters through a trough (so that all wheels go through the water or water solution) filled with water or a solution of a “marker” in water which is 1.5 cm deep. The part being tested is then checked to see if it is wet on the exposed side. If the part is wet it is considered exposed to salt in normal operation. If the part is normally hot in operation and the water would evaporate quickly, a marker substance is used in the water and part checked for the marker. The marker may be a salt (a white salt deposit will remain) of a chemical such as fluorescein that can be observed using ultraviolet light. If the marker chemical is on the part, the part is considered as exposed to salt in normal operation. This test simulates moving on a highway that may be covered with salt particles from melting ice or snow and/or a salt solution, and the resulting saltwater spray that is thrown onto the vehicle.

In developing blends of polyamides and ionomers, zinc ionomers have been preferred due to the interaction between Zn cations, divalent transition metal cations, and both amide and amine groups of polyamide. This physical interaction enhances the compatibility of the blend. Ionomers with sodium or potassium cations have been disclosed to be poor choices for blending with polyamides due to the poor compatibility, their tendency to absorb larger amounts of water, and poor UV stability (see for example U.S. Pat. No. 5,866,658).

We have discovered a methodology for enhancing the salt crack resistance of polyamide materials, particularly for those with a lower ratio of methylene to amide groups in the polyamide, such as nylon 66 or nylon 66/6T. We have surprisingly discovered that polyamide modified with ionomers containing a mixture of zinc and alkali metal cations exhibits unexpected excellent salt resistance, while maintaining low water absorption. Preferred are ionomers with a mixture of Zn cations and Na or Li cations. An article comprising the modified polyamide composition exhibits salt stress crack behavior when tested according to ASTM D1693 that is better than an article comprising a comparison composition comprising the polyamide that does not contain the ionomer with a mixture of zinc cations and sodium or lithium cations. Most preferred are ionomers with a mixture of Zn cations and Na cations.

Also surprisingly, the modified polyamide compositions show less than expected degradation when subjected to heat aging at temperatures higher than the typical use temperatures of the ionomers. An article comprising the composition exhibits improved retention of tensile strength and elongation when treated at 230° C. that is better than an article comprising a comparison composition comprising the polyamide that does not contain the ionomer with a mixture of zinc cations and sodium or lithium cations.

Polyamides (abbreviated PA), also referred to as nylons, are condensation products of one or more dicarboxylic acids and one or more diamines, and/or one or more aminocarboxylic acids such as 11-aminododecanoic acid, and/or ring-opening polymerization products of one or more cyclic lactams such as caprolactam and laurolactam. Polyamides may be fully aliphatic or semi-aromatic.

Polyamides from single reactants such as lactams or amino acids, referred to as AB type polyamides are disclosed in Nylon Plastics (edited by Melvin L. Kohan, 1973, John Wiley and Sons, Inc.) and include nylon-6, nylon-11, nylon-12. Polyamides prepared from more than one lactam or amino acid include nylon-6,12.

Other well known polyamides include those prepared from condensation of diamines and diacids, referred to as AABB type polyamides (including nylon-66, nylon-610 and nylon-612), as well as from a combination of lactams, diamines and diacids such as nylon-6/66, nylon-6/610, nylon-6/66/610, nylon-66/610, or combinations of two or more thereof.

Fully aliphatic polyamides used in the resin composition are formed from aliphatic and alicyclic monomers such as diamines, dicarboxylic acids, lactams, aminocarboxylic acids, and their reactive equivalents. In this context, the term “fully aliphatic polyamide” also refers to copolymers derived from two or more such monomers and blends of two or more fully aliphatic polyamides. Linear, branched, and cyclic monomers may be used.

Carboxylic acid monomers comprised in the fully aliphatic polyamides include, but are not limited to aliphatic dicarboxylic acids, such as for example adipic acid (C6), pimelic acid (C7), suberic acid (C8), azelaic acid (C9), decanedioic acid (C10) and dodecanedioic acid (C12). Diamines can be chosen among diamines with four or more carbon atoms, including but not limited to tetramethylene diamine, hexamethylene diamine, octamethylene diamine, decamethylene diamine, dodecamethylene diamine, 2-methylpentamethylene diamine, 2-ethyltetramethylene diamine, 2-methyloctamethylenediamine, trimethylhexamethylenediamine and/or mixtures thereof.

Semi-aromatic polyamides include a homopolymer, a copolymer, a terpolymer or more advanced polymers formed from monomers containing aromatic groups. One or more aromatic carboxylic acids may be terephthalic acid or a mixture of terephthalic acid with one or more other carboxylic acids, such as isophthalic acid, phthalic acid, 2-methyl terephthalic acid and naphthalic acid. In addition, the one or more aromatic carboxylic acids may be mixed with one or more aliphatic dicarboxylic acids, as disclosed above. An example semiaromatic polyamide is nylon-66/6T.

For copolymers disclosed herein, the repeat units are listed in decreasing order of mole % repeat units present in the copolymer. The following list exemplifies the abbreviations used to identify monomers and repeat units in the homopolymer and copolymer polyamides.
HMD hexamethylene diamine (or 6 when used in combination with a diacid)
T Terephthalic acid
AA Adipic acid
6 ε-Caprolactam
I Isophthalic acid
6T polymer repeat unit formed from HMD and T
66 polymer repeat unit formed from HMD and AA
6 polymer repeat unit formed from ε-caprolactam

Note that in the art the term “6” when used alone designates a polymer repeat unit formed from ε-caprolactam. Alternatively “6” when used in combination with a diacid such as T, for instance 6T, the “6” refers to HMD. In repeat units comprising a diamine and diacid, the diamine is designated first. Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

The advantages of improved salt stress crack resistance are particularly useful for polyamides with a lower ratio of methylene units to amide groups, including those with a ratio of five or less methylene units per amide group such as nylon-66, nylon-6/66, and nylon-66/6T and more preferably nylon-66 and nylon-66/6T.

The polyamide component may consist essentially of nylon-66 or nylon 66/6T. Nylon-66 is commonly used in the industry and has low cost, but has poor CaCl₂ resistance, so a method to improve its salt stress crack resistance is particularly desirable.

In other embodiments the polyamide component comprises nylon-66 or nylon 66/6T with up to 40 weight % of one or more additional polyamides selected from among the following: nylon-6, nylon-610, nylon-612, nylon-11 and nylon-12. In these embodiments the additional polyamide may be present in a range from a lower limit of about 0.1, 1.0, 5 or 10 weight % to an upper limit of about 10, 20 or 40 weight % of the polyamide component. Replacement of a portion of the nylon-66 or nylon 66/6T with any of nylon-610, nylon-612, nylon-11 and nylon-12 that have inherently better metal halide resistance may enhance CaCl₂ resistance compared to a composition comprising a polyamide component containing only nylon-66 or nylon 66/6T, but would increase cost. Replacement of a portion of the nylon-66 or nylon 66/6T with nylon-6 would reduce cost and might not significantly lower the CaCl₂ resistance compared to a composition with only nylon-66 or nylon 66/6T.

The relative viscosity (RV) of the polyamide used herein is from about 2.5 to about 4.0, preferably from about 2.7 to about 3.5. Relative viscosity may be measured by different methods depending on the polyamide used. The RV of nylon-66 is commonly measured according to ISO Test Method 307 using a solution of 1% of polymer in 90% formic acid. The RV of nylon-6 is commonly measured according to ISO Test Method 307 using a solution of 1% of polymer in 96% sulfuric acid.

Most common nylon-66 or nylon 66/6T grades used for molding and extrusion applications are suitable. For example, extrusion grades with a RV of about 3.3 and molding grades with a RV of about 2.7 are suitable. Mixtures of polyamides with different RV may be used as the polyamide component. For example, mixtures of 30 to 70 weight % of polyamide with RV of around 2.7 with 70 to 30 weight % of polyamide with RV around 3.3 may be used. Salt stress crack resistance may be enhanced when higher RV polyamides are used. Accordingly, the higher RV polyamide is desirably used in at least 50 weight % of the polyamide mixture.

Because polyamides and processes for making them are well known to one skilled in the art, detailed description of their preparation is omitted herein for the interest of brevity.

Suitable ionomers useful in the composition are ethylene acid copolymers comprising in-chain copolymerized units of ethylene and in-chain copolymerized units of an α,β-unsaturated C₃-C₈ monocarboxylic acid; at least partially neutralized to salts comprising zinc cations or alkali metal cations such as sodium or lithium, or a combination of such cations.

The α,β-unsaturated C₃-C₈ monocarboxylic acid may be acrylic acid or methacrylic acid, and the monocarboxylic acid may be present in the copolymer in an amount from about 3 to about 20 weight %, or about 12 to about 20 weight %, or about 4 to about 15 weight % or about 16 to about 20 weight % of the copolymer.

The ethylene acid copolymer may also optionally include other comonomers such as alkyl acrylates and alkyl methacrylates wherein the alkyl groups have from 1 to 8 carbon atoms such as methyl acrylate, ethyl acrylate and n-butyl acrylate. These comonomers, when present, can be from 0.1 to about 30 weight % based on the total weight of the copolymer, or about 3 to about 25 weight %. The optional alkyl acrylates and alkyl methacrylates provide softer acid copolymers that after neutralization form softer ionomers.

Of note are ethylene acid dipolymers consisting essentially of copolymerized units of ethylene and copolymerized units of monocarboxylic acid (that is, the amount of alkyl acrylate or alkyl methacrylate is 0 weight %), and ionomers thereof. Preferably the monocarboxylic acid is acrylic acid or methacrylic acid. Notable copolymers contain 12 to 20 weight % of acrylic acid or methacrylic acid.

The acid copolymers may be obtained by high-pressure free radical polymerization, wherein the comonomers are directly copolymerized with ethylene by adding all comonomers simultaneously. This process provides copolymers with “in-chain” copolymerized units derived from the monomers, where the units are incorporated into the polymer backbone or chain. These copolymers are distinct from a graft copolymer, in which acid comonomers are added to an existing polymer chain via a post-polymerization grafting reaction, often by a free radical reaction.

These copolymers are treated so that at least some of the carboxylic acid groups present are neutralized to form salts with zinc or alkali metal cations to provide ionomers useful in the compositions described herein.

Neutralization of an ethylene acid copolymer can be effected by first making the ethylene acid copolymer and treating the copolymer with basic compound(s) comprising zinc and/or alkali metal cations. The copolymer may be neutralized so that from about 10 to about 90%, preferably 30 to 90% of the available carboxylic acid groups in the copolymer are neutralized to salts with at least one metal ion selected from lithium, sodium, zinc, or combinations of such cations. For example, from about 10 to about 70 or about 30 to about 70% of the available carboxylic acid groups may be ionized by treatment with basic compound(s) (neutralization) with at least one metal ion selected from sodium, zinc, or lithium.

Non-limiting, illustrative examples of ethylene acid copolymers useful in ionomers include E/15MAA, E/19MAA, E/15AA, E/19AA, E/15MAA, E/19MAA, E/10MAA/4iBA, E/10MAA/9.8iBA, E/9MAA/23nBA, (wherein E represents ethylene, MAA represents methacrylic acid, AA represents acrylic acid, iBA represents isobutyl acrylate, nBA represents n-butyl acrylate, and the numbers represents the weight % of comonomers present in the copolymer).

Suitable zinc- or alkali metal-neutralized ethylene acid copolymers or terpolymers are sold under the trademark SURLYN® brand resins by E.I. du Pont de Nemours and Company (DuPont) of Wilmington, Del. Mixed ion ionomers are not commercially available. As described in greater detail below, a mixed ion ionomer can be prepared by melt blending a zinc-neutralized ionomer with an alkali metal-neutralized ionomer.

The neutralized acid copolymer used in the instant compositions comprises a mixed metal salt of cations of zinc (Zn) and a second metal (M2) that is different from Zn, selected from Group 1 of the Periodic Table of the Elements, wherein Zn cations comprise about 20 to about 90% mole equivalents and M2 cations comprise about 80 to 10% mole equivalents. Preferred are compositions wherein M2 is sodium, lithium or a mixture thereof; more preferably M2 is sodium. Preferably Zn cations comprise about 30 to about 70% mole equivalents of the total cations. Certain mixed ion ionomers are described in greater detail in U.S. Pat. No. 6,680,082.

Alternatively the mixed ion ionomers can be described in terms of the ratio of equivalents from zinc cations to equivalents from M2 cations. For example, a desirable ratio is from about 0.6 to about 6, corresponding to between about 38 to about 86% of the neutralized acid groups being neutralized to salts with zinc cations. Preferably, the equivalent ratio is from about 0.7 to about 3, or from about 41 to about 75% of the neutralized acid groups neutralized to salts with zinc cations.

The mixed ion ionomer useful for blending with polyamides as described herein may be obtained by neutralizing an acid copolymer described above with a combination of a basic compound containing zinc cations and a basic compound containing alkali metal cations. Another method may be using an alkali metal ionomer or combination of alkali metal ionomers and neutralizing to a higher level with a basic compound containing zinc cations.

Alternatively, the mixed ion ionomer may be obtained by combining an ionomer containing zinc cations and an ionomer containing alkali metal cations. In such cases, the ethylene acid copolymer used as the base polymer in the zinc ionomer may be the same as, or different from, the ethylene acid copolymer used as the base polymer in the alkali metal ionomer. Also, the different ionomers may be melt-blended together with the polyamide, thereby forming the mixed ion ionomer and blending with the polyamide in a single step.

The composition or blend can comprise about 0.0001, 0.01 or 0.1 or 1 weight % to about 1, 5, 10, 20, or 30 weight %, based on the weight of the entire composition including the polyamide/mixed ion ionomer blend, of optional additives including stabilizers, antioxidants, ultraviolet ray absorbers, hydrolytic stabilizers, anti-static agents, dyes or pigments, fire-retardants, processing aids such as lubricants, antiblock agents, release agents, or combinations of two or more thereof. Lubricants of note include salts of fatty acids such as zinc stearate or fatty amides such as stearamide, which may be added at about 0.1 to 1 weight % of the total composition.

The blend may also contain phosphorous salts such as a hypophosphite salt. Suitable phosphorous salts for use in the blends are described in greater detail in U.S. Pat. No. 6,399,684. The salts, including sodium, lithium, or potassium hypophosphite may be added to the blend composition in about 0.1 to about 3 weight % of the composition. Hypophosphite salts may provide improved morphological or physical properties to the blend such as increased Vicat temperature and/or improved tensile properties.

Of note is a composition as described herein consisting essentially of (1) a polyamide as described above; (2) a mixed-ion ionomer as described above; and (3) reinforced agents, such as glass fiber, (4) optionally other additives such as a hypophosphite salt.

The composition or blend can optionally comprise additional non-ionomeric thermoplastic materials blended with the polyamide and ionomer to allow one to more easily modify the properties of the composition by manipulating the amount and type of additional components present in the composition in addition to varying the percentages of the monomers in the ethylene acid copolymner; or to allow for easier, lower cost manufacture of the composition by allowing one to prepare fewer base resins that can be subsequently modified to obtain desired properties, or to substitute a portion of the composition with a less expensive material. To retain the desired benefits, the additional thermoplastic material may be present in the composition in an amount up to about 30% of the total polymeric material, such as from a lower limit of 1 or 5 weight % to an upper limit of 10, 15 or 20 weight % of the total polymeric material.

Non-ionomers include copolyetheramides, elastomer polyolefins, styrene diene block copolymers (e.g., styrene-butadiene-styrene (SBS)), thermoplastic elastomers, thermoplastic polyurethanes (e.g., polyurethane), polyetherester, polyether-urea, PEBAX (a family of block copolymers based on polyether-block-amide, commercially supplied by Atochem), styrene(ethylene-butylene)-styrene block copolymers, etc., polyesters, polyolefins (e.g., polyethylene, polypropylene, or ethylene/propylene copolymers), ethylene copolymers (with one or more comonomers including vinyl acetate, (meth)acrylates, (meth)acrylic acid, epoxy-functionalized monomer, CO, etc., functionalized polymers with maleic anhydride, or epoxidization), grafting, elastomers such as EPDM, metallocene catalyzed PE and copolymner, ground up powders of the thermoset elastomers, or combinations of two or more thereof.

Some of the thermoplastic materials may be useful as impact modifiers for the polyamide-mixed ionomer blend. Example impact modifiers include polyethylene, ethylene-propylene dipolymers or terpolymers with an additional α-olefin grafted with a carboxylic acid or anhydride, or ethylenepropylene diene mononomer (EPDM), each grafted with a carboxylic acid or anhydride. Preferably the anhydride is maleic anhydride. Such impact modifiers are described in greater detail in U.S. Pat. No. 6,420,481. The impact modifiers may be included in the composition in about 1 to about 15 weight %, or from about 5 to about 10 weight % of the total composition. Inclusion of impact modifiers may be useful in providing good low-temperature impact resistance.

The thermoplastic melt-mixed composition and thermoplastic articles prepared therefrom may comprise from a lower limit of about 0.1, about 1, about 5 or about 10, to an upper limit of about 40 or about 50 weight percent of the total composition, such as about 1 to about 50 weight percent, and preferably about 5 to about 50 weight percent, or about 10 to about 50 weight percent, or about 10 to about 40 weight percent, of one or more reinforcement agents. The reinforcement agent may be any filler, but is preferably calcium carbonate, glass fibers with circular cross-section, glass fibers with noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate or mixtures thereof.

Glass fibers with noncircular cross-section refer to glass fiber with a cross section having a major axis lying perpendicular to a longitudinal direction of the glass fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape, a rectangular shape; an elliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fibers are disclosed in EP0190001 and EP0196194.

Preferably the reinforcing agent is selected from glass fibers with circular cross-section or glass fibers with noncircular cross-section.

Of note is a composition as described herein consisting essentially of (1) a polyamide as described above; (2) a mixed-ion ionomer as described above; (3) a sulfonamide; wherein the composition is substantially free of any additional thermoplastic materials; and (4) reinforcing agent.

Also of note is a composition as described herein consisting essentially of (1) a polyamide as described above; (2) a mixed-ion ionomer as described above; (3) hypophosphite salt; (4) a sulfonamide; and (5) reinforcing agent.

The composition can be used to fabricate vehicular parts, preferably made by injection molding, particularly those parts that are exposed to salt in normal vehicle operation. Such vehicular parts include cooling system components, intake manifolds, oil pans, transmission cases, electrical and electronic housings, fuel system components, filter housings, coolant pump covers, and radiator end tanks. These polyamide compositions have properties that make them especially useful for such parts, for example one or more of good resistance to heat, the various fluids found in vehicles especially fuel, hydraulic fluid, and cooling fluid, and excellent mechanical strength, and excellent CaCl₂ salt resistance.

### EXAMPLES

The following Examples are merely illustrative, and are not to be construed as limiting the scope of the invention.

### Materials

For the materials listed below, Relative viscosity (RV) measured according to ISO 307 was reported by the commercial supplier. Melt Index was determined according to ASTM D1238 at 190° C. using a 2.16 kg weight.
PA-1: nylon-66.
PA-2: nylon-66/6T, containing 25% 6T.
PA-3: nylon-612.
ION-1: a zinc ionomer based on an ethylene methacrylic acid dipolymer with 15 weight % of MAA with a MI of 60 measured at 190° C. with 2.16 kg weight, neutralized to salts with Zn cations (58% neutralization), MI of 0.7 g/10 minutes measured at 190° C. with 2.16 kg weight, with 800 ppm moisture.
ION-2: a sodium ionomer based on an ethylene methacrylic acid dipolymer with 15 weight % of MAA with a MI of 60 measured at 190° C. with 2.16 kg weight, neutralized to salts with Na cations (59% neutralization), MI of 0.9 g/10 minutes measured at 190° C. with 2.16 kg weight, with 800 ppm moisture.
ION-3: a zinc ionomer based on an ethylene methacrylic acid dipolymer with 19 weight % of MAA with a MI of 60 measured at 190° C. with 2.16 kg weight, neutralized to salts with Zn cations (36% neutralization), MI of 1.3 g/10 minutes measured at 190° C. with 2.16 kg weight.
ION-4: a sodium ionomer based on an ethylene methacrylic acid dipolymer with 19 weight % of MAA with a MI of 250 measured at 190° C. with 2.16 kg weight, neutralized to salts with Na cations (45% neutralization), MI of 4.5 g/10 minutes measured at 190° C. with 2.16 kg weight.
Zinc stearate: commercial grade.
Aluminum Stearate: commercial grade.
Stearamide: available commercially under the tradename Kemamide® from Chemtura.
HS-1: a mixture of KI, CuI and aluminum stearate used as a heat stabilizer.
Pigment-1: a black pigment comprising 40% nigrosine dye in nylon-6.

Note that ION-1 and ION-2 are based on the same E/MAA base resin prior to neutralization and ION-3 and ION-4 are based on different E/MAA base resins prior to neutralization.

Extrusion/Processing Conditions

All blend samples were made on a 30-mm twin-screw extruder, typically with 260° C. barrel temperature settings and screw speed of 300 rpm. Polyamide and ionomer were fed at the back end of the extruder, followed by an intense kneading section in the extruder screw to disperse these ingredients. When included, plasticizer was injected into the extruder barrel after the initial mixing section, and this liquid injection was followed by additional intense mixing elements. The melt strand from the extruder was water quenched and cut into pellets for collection and subsequent molding and evaluation.

Injection Molding

Testing specimens, plaques and tensile bars were molded on either a 1.5 oz Arburg or a 6 oz Nissei injection molding machine, using a standard screw and nozzle. Barrel settings were typically 260° C., and injection pressure and cycle time were adjusted to accommodate the melt viscosity of the given sample.

Methods Employed for Testing

The tensile strength, modulus and elongation at break were measured according to ASTM D1708, “Standard Test Method for Tensile Properties of Plastics by use of Microtensile Specimens” using crosshead speed of 10 in/min. Dimensions of specimens were 0.185 inch width×0.125 inch thickness×0.875 inch length,

Melt viscosity was measured at 280° C. using a Kayeness melt rheometer of a 0.04 inch×0.8 inch 20/1 L/D orifice. A six minute holdup/melt time in the rheometer barrel was used before measurements were taken. Melt viscosity of the polyamides was measured at shear rates of 3003, 1194, 475, 186, 81, 35 and 12 sec⁻¹.

TABLE 1
Melt viscosity at 280° C. (Pa · sec)

| | Shear rate (sec⁻¹) | | | | | | |
|---|---|---|---|---|---|---|---|
| Sample | 3003 | 1194 | 475 | 186 | 81 | 35 | 12 |
| PA-1 | 74 | 100 | 121 | 135 | 144 | 147 | 153 |
| PA-2 | 70 | 94 | 100 | 135 | 154 | 179 | 248 |

Notched Izod impact was measured on (5 inch×0.5 inch×0.125 inch) test bars according to ASTM D256.

The water absorption is measured by immersing a specimen of 3 inch×3 inch×0.125 inch plaques in water at room temperature (20 to 25° C.) for 7 days or at 80° C. for four hours, removing the specimen from water, blotting the water from the surface of the plaque and weighing to determine weight gain.

The environmental stress cracking test was measured according to ASTM D1693. The purpose of this test is to measure the chemical resistance of a compound by artificially stimulating a stress introduced into a sample by means of a stress crack or “nick.” Ten specimens of each composition sample were used. The size of the test specimen was 1.5 inch long×0.5 inch wide×0.125 inch thick. The test specimens were nicked, then placed into a holder so that they were held in a bent configuration with the nicked side facing up. The specimens were then immersed in 50 weight % aqueous calcium chloride solution. The CaCl₂ (50%) stress cracking tests were conducted at both 80° C. and 90° C. according to ASTM 1693. The specimens were inspected periodically for formation of cracks which indicated failure of the specimen. At the end of 168 hours, the test was ended and the total number of failures out of the ten specimens tested was recorded. When no samples failed during that time, the test results were reported as being greater than 7 days.

Listed in Tables 2 through 4 are representative data for blends as described herein,

Compositions using PA-1 or PA-2 were prepared and processed into test specimens as described above using the amounts of components summarized in Table 2. The ionomers employed were Na ionomers and Zn ionomers. The samples were prepared in a one-step process, blending polyamides and the ionomer(s) together in one extrusion melt blending. In the following Tables, Equivalent Ratio is the number of equivalents provided by the zinc salts divided by the number of equivalents provided by the sodium salts.

TABLE 2

| | | | | | Zn | | Equivalent |
|---|---|---|---|---|---|---|---|
| | Polyamide | | Ionomer | | Stearate | Neutralization | Ratio of |
| Example | Type | Weight % | Type | Weight % | Weight % | Level | Zn/M2 |
| C1 | PA-1 | 99.25 | | 0 | 0.75 | NA | NA |
| C2 | PA-2 | 99.25 | | 0 | 0.75 | NA | NA |
| 1 | PA-1 | 64.25 | ION-1 | 17.5 | 0.75 | 58.5 | 0.98 |
| | | | ION-2 | 17.5 | | | |
| 2 | PA-1 | 59.25 | ION-1 | 20 | 0.75 | 58.5 | 0.98 |
| | | | ION-2 | 20 | | | |
| 3 | PA-2 | 74.25 | ION-1 | 12.5 | 0.75 | 58.5 | 0.98 |
| | | | ION-2 | 12.5 | | | |
| 4 | PA-2 | 69.25 | ION-1 | 15 | 0.75 | 58.5 | 0.98 |
| | | | ION-2 | 15 | | | |
| C5 | PA-2 | 64.25 | ION-1 | 35 | 0.75 | 58 | 100% Zn |
| 6 | PA-2 | 64.25 | ION-1 | 17.5 | 0.75 | 58.5 | 0.98 |
| | | | ION-2 | 17.5 | | | |
| C7 | PA-2 | 64.25 | ION-2 | 35 | 0.75 | 59 | 100% Na |
| 8 | PA-2 | 59.25 | ION-1 | 20 | 0.75 | 58.5 | 0.98 |
| | | | ION-2 | 20 | | | |
| 9 | PA-2 | 74.25 | ION-3 | 12.5 | 0.75 | 40.5 | 0.8 |
| | | | ION-4 | 12.5 | | | |
| 10 | PA-2 | 69.25 | ION-3 | 15 | 0.75 | 40.5 | 0.8 |
| | | | ION-4 | 15 | | | |

The properties of the compositions are summarized in Tables 3 and 4.

TABLE 3

| | | Tensile Properties (125° C.) | | |
|---|---|---|---|---|
| | CaCl₂ Stress Test at 80° C. | Modulus | Strength | Elongation |
| Example | (time to fail) | (MPa) | (MPa) | (%) |
| C1 | Failed (cracked) in | 241 | 79 | 530 |
| | less than 1 hour | | | |
| 1 | >7 days | 160 | 33 | 355 |
| 2 | >7 days | 151 | 31 | 342 |

As shown in Table 3, nylon-66 (Comparative Example C1) failed the CaCl₂ stress test in less than one hour, while the two blends containing ionomer passed the test for over 7 days.

TABLE 4

CaCl₂ Stress Test (time to fail)

| Example | 80° C. | 90° C. |
|---|---|---|
| C2 | Failed (no crack, surface crazed); 7 days | <3 day |
| 3 | >7 days | <5 days |
| 4 | >7 days | <5 days |
| C5 | >7 days | >7 days |
| 6 | >7 days | >7 days |
| C7 | >7 days | >7 days |
| 8 | >7 days | >7 days |
| 9 | >7 days | >7 days |
| 10 | >7 days | >7 days |

As shown in Table 4, nylon 66/6T (PA-2), having much better inherent CaCl₂ resistance than nylon 66, still failed the CaCl₂ stress test at both 80 and 90° C. The blends with ionomers all exhibited much better CaCl₂ resistance. For example, at only 25 weight % loading of a mixture of Na and Zn ionomers, Example 9 passed CaCl₂ resistance at both 80° C. and °90 C. Ionomers with higher levels of acid copolymers, such as from about 16 to about 20 weight % of acid may provide better CaCl₂ resistance than those with lower amounts of acid.

Additional Examples were prepared using the materials summarized in Tables 5 through 11. Calcium chloride salt stress tests were conducted on samples without fiberglass filler using a 50% CaCl₂ solution at 95° C. The sample was judged to have failed when cracks became visible on the surface of the test plaque. The tests were stopped at 14 days, so samples that did not fail in that time were scored as “>14” days. The polymer blends were then blended with fiberglass to provide filled samples for physical and mechanical property testing.

TABLE 5

| | | | | | | CaCl₂ |
|---|---|---|---|---|---|---|
| | | | | | | Stress Test |
| Example | PA-2 | ION-1 | ION-2 | ION-3 | ION-4 | (days to fail) |
| C11 | 100 | | | | | 3 |
| 12 | 75 | 12.5 | 12.5 | | | 5 |
| 13 | 70 | 15 | 15 | | | 5 |
| 14 | 65 | 35 | | | | >14 |
| 15 | 65 | 17.5 | 17.5 | | | >14 |
| 16 | 60 | 20 | 20 | | | >14 |
| 17 | 75 | | | 12.5 | 12.5 | 5; >14 |
| 18 | 70 | | | 15 | 15 | >14 |

The compositions in Table 6 had 0.45 weight % of HS-1 and 0.1 weight % of aluminum stearate in addition to the polymeric materials listed.

TABLE 6

| | | | | | CaCl₂ Stress Test |
|---|---|---|---|---|---|
| Example | PA-1 | PA-2 | ION-3 | ION-4 | (days to fail) |
| C19 | 100 | | | | 1 |
| C20 | 90 | | 5 | 5 | 1 |
| C21 | 85 | | 7.5 | 7.5 | 1 |
| 22 | 80 | | 10 | 10 | 1 |
| 23 | 75 | | 12.5 | 12.5 | 1 |
| 24 | 70 | | 15 | 15 | 1 |
| C25 | | 90 | 5 | 5 | 2 |
| 26 | | 85 | 7.5 | 7.5 | 1 |
| 27 | | 80 | 10 | 10 | 3 |
| 28 | | 75 | 12.5 | 12.5 | 5 |
| 29 | | 70 | 15 | 15 | 5 |
| C30 | | 100 | | | 3 |

TABLE 7

| | Example | | | | | | |
|---|---|---|---|---|---|---|---|
| | C31F | 32F | C33F | 34F | 35F | 36F | C37F |
| PA-2 | 42.54 | 42.54 | 42.54 | 39.27 | 49.09 | 45.82 | 65.45 |
| ION-1 | 22.91 | 11.46 | | 13.09 | | | |
| ION-2 | | 11.46 | 22.91 | 13.09 | | | |
| ION-3 | | | | | 8.18 | 9.82 | |
| ION-4 | | | | | 8.18 | 9.82 | |
| CPIC 301HP fiberglass | 33.00 | 33.00 | 33.00 | 33.00 | 33.00 | 33.00 | 33.00 |
| HS-1 | 0.45 | 0.45 | 0.45 | 0.45 | 0.45 | 0.45 | 0.45 |
| Pigment-1 | 1.00 | 1.00 | 1.00 | 1.00 | 1.00 | 1.00 | 1.00 |
| Aluminum Stearate | 0.10 | 0.10 | 0.10 | 0.10 | 0.10 | 0.10 | 0.10 |
| Tensile Strength (MPa) | 139 | 138 | 133 | 125 | 158 | 141 | 204 |
| Elongation (%) | 4.5 | 3.9 | 3.0 | 3.7 | 4.1 | 3.6 | 3.4 |
| Flex Strength (MPa) | 204 | 204 | 193 | 180 | 241 | 203 | 204 |
| Flex Modulus (MPa) | 6730 | 7140 | 7412 | 6640 | 7710 | 6670 | |
| Notched Charpy (kJ/m²) | 18.8 | 18.4 | 14.1 | 19.1 | 18.5 | 17.1 | 12.8 |
| Melt Viscosity | 419 | 475 | 364 | 425 | 474 | 542 | 220 |
| at 0.13% (Pa-s) | | | | | | | |

TABLE 8

| | Example | | | | | | | | | |
|---|---|---|---|---|---|---|---|---|---|---|
| | 38F | 39F | 40F | 41F | 42F | 43F | 44F | 45F | C46F | C47F |
| | Weight % | | | | | | | | | |
| PA-2 | 48.7 | 35.7 | 42.2 | 42.2 | 42.2 | 38.9 | 48.7 | 45.4 | 64.9 | |
| PA-1 | | | | | | | | | | 64.9 |
| ION-1 | 8.1 | 19.5 | 22.7 | 11.4 | | 13.0 | | | | |
| ION-2 | 8.1 | 9.7 | | 11.4 | 22.7 | 13.0 | | | | |
| ION-3 | | | | | | | 8.1 | 9.7 | | |
| ION-4 | | | | | | | 8.1 | 9.7 | | |
| Licowax OP | 0.1 | 0.1 | 0.1 | 0.1 | 0.1 | 0.1 | 0.1 | 0.1 | 0.1 | 0.1 |
| CPIC 301HP | 35 | 35 | 35 | 35 | 35 | 35 | 35 | 35 | 35 | 35 |
| fiberglass | | | | | | | | | | |
| Tensile Strength | 151 | 116 | 149 | 126 | 107 | 123 | 152 | 138 | 212 | 219 |
| (MPa) | | | | | | | | | | |
| Elongation | 3.8 | 3.5 | 5.7 | 3.1 | 1.8 | 3.0 | 3.8 | 3.4 | 3.6 | 3.7 |
| (%) | | | | | | | | | | |

TABLE 9

| | Example | | | | | | |
|---|---|---|---|---|---|---|---|
| | C48 | 49 | C50 | 51 | 52 | 53 | C54 |
| | Weight % | | | | | | |
| PA-1 | 65 | 65 | 65 | 60 | 75 | 70 | 100 |
| ION-1 | 35 | 17.5 | | 20 | | | |
| ION-2 | | 17.5 | 35 | 20 | | | |
| ION-3 | | | | | 12.5 | 15 | |
| ION-4 | | | | | 12.5 | 15 | |
| CaCl₂ Stress Test | 1 | 1 | <1 | 1 | 1 | 1 | 1 |
| (days to fail) | | | | | | | |
| Notched Izod (KJ/m²) | 90.8 | 76.6 | 26.3 | 84.8 | 15.1 | 17.2 | 75.6 |

TABLE 10

| | Example | | | | |
|---|---|---|---|---|---|
| | C55 | C56 | 57 | 58 | 59 |
| | Weight % | | | | |
| PA-1 | 90 | 85 | 80 | 75 | 70 |
| ION-3 | 5 | 7.5 | 10 | 12.5 | 15 |
| ION-4 | 5 | 7.5 | 10 | 12.5 | 15 |
| CaCl₂ Stress Test (days to fail) | 1 | 1 | >14 | >14 | >14 |

The CaCl₂ stress tests conducted at 95° C. are much more severe than at lower temperatures, and consequently test results of similar samples can vary significantly. For example, Examples 52 and 58 and Examples 53 and 59 have similar compositions, but have different results in their respective CaCl₂ Stress Tests. Table 10 demonstrates the improved stress crack resistance for compositions with at least 20 weight % of mixed ionomers compared to compositions with less ionomer (C55 and C56).

The filled samples summarized in Table 11 also were tested for the effects of heat aging on the tensile strength and elongation. After the properties of filled samples were tested directly after molding, additional samples were aged at 230° C. for 250, 500 and 1000 hours. The results for blends with PA-1 are summarized in Table 11. “Retention” is the percentage of the property measured before heat aging that was maintained after aging.

TABLE 11

| | | Example | | | | | |
|---|---|---|---|---|---|---|---|
| | Time (h) at | 60F | 61F | 62F | 63F | 64F | C65F |
| | 230° C. | Weight % | | | | | |
| PA-1 | | 58.01 | 51.56 | 41.62 | 38.12 | 34.62 | 64.55 |
| ION-3 | | 3.22 | 6.45 | 8.92 | 8.17 | 7.42 | |
| ION-4 | | 3.22 | 6.45 | 8.92 | 8.17 | 7.42 | |
| CPIC 301HP fiberglass | | 35.00 | 35.00 | 40.00 | 45.00 | 50.00 | 35 |
| HS-1 | | 0.45 | 0.45 | 0.45 | 0.45 | 0.45 | 0.3 |
| Aluminum Stearate | | 0.10 | 0.10 | 0.10 | 0.10 | 0.10 | 0.075 |
| Stearamide | | 0 | 0 | 0 | 0 | 0 | 0.075 |
| Tensile Strength, (MPa) | 0 | 194 | 177 | 168 | 168 | 169 | 212 |
| Retention (%) | 250 | 166 | 211 | 202 | 201 | 203 | 136 |
| | 250 | 86 | 119 | 120 | 120 | 120 | 64 |
| Retention (%) | 500 | 36 | 174 | 188 | 177 | 143 | 21 |
| | 500 | 18 | 98 | 111 | 106 | 84 | 10 |
| Retention (%) | 1000 | 2 | 84 | 143 | 81 | 25 | — |
| | 1000 | 1 | 47 | 85 | 48 | 15 | — |
| Elongation (%) | 0 | 6.0 | 6.2 | 5.7 | 5.2 | 4.9 | 6.0 |
| | 250 | 4.4 | 6.4 | 6.2 | 5.8 | 5.4 | 3.6 |
| | 250 | 73 | 104 | 108 | 111 | 109 | 59 |
| Retention (%) | 500 | 0.8 | 4.6 | 5.6 | 4.5 | 3.5 | 0.7 |
| | 500 | 14 | 74 | 98 | 86 | 71 | 11 |
| Retention (%) | 1000 | 0.2 | 2.5 | 3.5 | 2.7 | 0.9 | — |
| | 1000 | 3 | 40 | 62 | 51 | 17 | |

The heat aging data in Table 11 show that filled blends of PA-1 (nylon-66) with ionomers had significantly better retention of tensile strength and elongation compared to filled PA-1 without ionomers (Comparative Example C65F). Higher levels of the mixed ionomer modifier provided better retention of properties after heat aging. This is a surprising and unexpected result, considering that the heat aging was conducted at temperatures significantly higher than the use temperatures typically found for ionomer compositions.

Additional samples were prepared from the materials summarized in Tables 12 and 13. The tensile strength of each material was measured.

TABLE 12
Blends of PA-1 and ionomer (glass-filled)

| | | Weight % | | |
|---|---|---|---|---|
| Example | Ionomer ID | Ionomer | glass | Tensile Strength, MPa |
| 66 | 1:1 ION-1/ION-2 | 35 | 33 | 164 |
| 67 | 1:1 ION-1/ION-2 | 40 | 33 | 136 |
| 88 | 1:1 ION-3/ION-4 | 25 | 33 | 129 |
| 69 | 1:1 ION-3/ION-4 | 30 | 33 | 171 |
| 70 | 1:1 ION-3/ION-4 | 20 | 35 | 177 |
| 71 | 1:1 ION-3/ION-4 | 30 | 40 | 168 |
| 72 | 1:1 ION-3/ION-4 | 30 | 45 | 168 |
| 73 | 1:1 ION-3/ION-4 | 30 | 50 | 169 |
| 74 | 1:1 ION-3/ION-4 | 20 | 33 | 168 |
| 75 | 1:1 ION-3/ION-4 | 25 | 33 | 162 |
| 76 | 1:1 ION-3/ION-4 | 30 | 33 | 150 |
| 77 | 1:1 ION-3/ION-4 | 20 | 35 | 177 |
| 78 | 1:1 ION-3/ION-4 | 20 | 33 | 168 |
| 79 | 1:1 ION-3/ION-4 | 25 | 33 | 129 |
| 80 | 1:1 ION-3/ION-4 | 25 | 33 | 162 |
| 81 | 1:1 ION-3/ION-4 | 30 | 33 | 171 |
| 82 | 1:1 ION-3/ION-4 | 30 | 40 | 168 |
| 83 | 1:1 ION-3/ION-4 | 30 | 45 | 168 |
| 84 | 1:1 ION-3/ION-4 | 30 | 50 | 169 |
| 85 | 1:1 ION-3/ION-4 | 30 | 33 | 150 |
| 86 | 1:1 ION-1/ION-2 | 35 | 33 | 164 |
| 87 | 1:1 ION-1/ION-2 | 40 | 33 | 136 |

TABLE 13
Blends of PA-2 and ionomer (glass-filled)

| | | Weight % | | |
|---|---|---|---|---|
| Example | Ionomer ID | Ionomer | glass | Tensile Strength, MPa |
| 88 | 1:1 ION-1/ION-2 | 25 | 35 | 151 |
| 89 | 2:1 ION-1/ION-2 | 45 | 35 | 116 |
| 90 | 1:1 ION-1/ION-2 | 35 | 35 | 126 |
| 91 | 1:1 ION-1/ION-2 | 40 | 35 | 123 |
| 92 | 1:1 ION-3/ION-4 | 25 | 35 | 152 |
| 93 | 1:1 ION-3/ION-4 | 30 | 35 | 138 |
| 94 | 1:1 ION-3/ION-4 | 20 | 33 | 163 |
| 95 | 1:1 ION-3/ION-4 | 25 | 33 | 156 |
| 96 | 1:1 ION-3/ION-4 | 30 | 33 | 147 |
| 97 | 1:1 ION-3/ION-4 | 20 | 33 | 163 |
| 98 | 1:1 ION-1/ION-2 | 25 | 35 | 151 |
| 99 | 1:1 ION-3/ION-4 | 25 | 35 | 152 |
| 100 | 1:1 ION-3/ION-4 | 25 | 33 | 156 |
| 101 | 1:1 ION-3/ION-4 | 30 | 35 | 138 |
| 102 | 1:1 ION-3/ION-4 | 30 | 33 | 147 |
| 103 | 1:1 ION-1/ION-2 | 35 | 35 | 126 |
| 104 | 1:1 ION-1/ION-2 | 40 | 35 | 123 |
| 105 | 2:1 ION-1/ION-2 | 45 | 35 | 116 |

1. A composition comprising
(a) about 60 to about 80 weight % %, based on the total weight of (a)+(b), of polyamide composition comprising nylon-66, nylon-6/66 or nylon 66/6T, and optionally up to 40 weight %, based on the total polyamide composition, of nylon-6, nylon-610, nylon-612, nylon-11, nylon-12 or mixtures thereof;
(b) about 20 to about 40 weight %, based on the total weight of (a)+(b), of an ionomer composition, wherein the ionomer composition comprises at least one copolymer comprising copolymerized units of ethylene, 3 to 20 weight % of copolymerized units of at least one α,β-unsaturated C₃-C₈ monocarboxylic acid and 0 to 30 weight % of copolymerized units of alkyl acrylate or alkyl methacrylate; and 30 to 90% of the total monocarboxylic acid functionalities are neutralized to salts with a mixture of zinc cations and sodium or lithium cations, wherein the salts comprise from 20 to 90% equivalents of zinc; and optionally
(c) reinforcing filler in the range of 0.1 to about 50 weight % of the total weight of (a), (b) and (c).

2. The composition of claim 1 wherein the at least one copolymer is a dipolymer consisting essentially of copolymerized comonomers of ethylene and 12 to 20 weight % of acrylic acid or methacrylic acid.

3. The composition of claim 1 wherein copolymerized units of alkyl acrylate or alkyl methacrylate are present in the copolymer from 0.1 to about 30 weight %.

4. The composition of claim 1 wherein the salts comprise a mixture of zinc and sodium cations.

5. The composition of claim 1 wherein the polyamide consists essentially of nylon-66.

6. The composition of claim 1 wherein the polyamide consists essentially of nylon-66/6T.

7. The composition of claim 1 wherein the polyamide comprises nylon-66 and 0.1 to 40 weight % of nylon-6, nylon-610, nylon-612, nylon-11, nylon-12 or mixtures thereof.

8. The composition of claim 1 wherein the polyamide comprises nylon-66/6T and 0.1 to 40 weight % of nylon-6, nylon-610, nylon-612, nylon-11, nylon-12 or mixtures thereof.

9. The composition of claim 1 wherein the ionomer composition comprises about 25 to about 40 weight %, of the total weight of (a)+(b).

10. composition of claim 1 wherein the composition further comprises non-ionomeric thermoplastic materials.

11. The composition of claim 10 comprising from 1 to 15 weight % of an impact modifier comprising polyethylene, ethylene-propylene dipolymer, ethylene-propylene terpolymer with an additional α-olefin, or ethylenepropylene diene mononomer, each grafted with a carboxylic acid or anhydride.

12. The composition of claim 1 wherein the composition exhibits salt stress crack behavior when tested according to ASTM D1693 that is characterized by standard test plaques that exhibit no cracks when exposed to 50% aqueous calcium chloride solution at about 80° C. for at least seven days.

13. The composition of claim 1 wherein the reinforcing filler is present,

14. The composition of claim 13 wherein the reinforcing filler comprises glass fiber.

15. The composition of claim 1 wherein an article comprising the composition exhibits salt stress crack behavior when tested according to ASTM D1693 that is better than an article comprising a comparison composition comprising the polyamide that does not contain the ionomer with a mixture of zinc cations and sodium or lithium cations.

16. The composition of claim 1 wherein an article comprising the composition exhibits improved retention of tensile strength and elongation when treated at 230° C. that is better than an article comprising a comparison composition comprising the polyamide that does not contain the ionomer with a mixture of zinc cations and sodium or lithium cations.

17. A method for improving the salt stress crack behavior of a polyamide composition, comprising
(a) providing a polyamide composition comprising nylon-66, nylon-6/66 or nylon 66/6T, and optionally up to 40 weight %, based on the total polyamide component, of nylon-6, nylon-610, nylon-612, nylon-11, nylon-12 or mixtures thereof;
(b) melt blending the polyamide with an ionomer comprising at least one copolymer comprising copolymerized units of ethylene, 3 to 20 weight % of copolymerized units of at least one α,β-unsaturated C₃-C₈ monocarboxylic acid and 0 to 30 weight % of copolymerized units of alkyl acrylate or alkyl methacrylate; and 30 to 90% of the total monocarboxylic acid functionalities are neutralized to salts with a mixture of zinc cations and sodium or lithium cations, wherein the salts comprise from 20 to 90% equivalents of zinc; to provide a molten blend composition comprising about 60 to about 80 weight % of the polyamide and about 20 to about 40 weight % of the ionomer;
(c) optionally blending in reinforcing filler in the range of about 0.1 to about 50 weight % of the total weight of polyamide, ionomer and filler;
(d) shaping the molten blend composition into a defined shape;
(e) allowing the shaped molten blend composition to cool, thereby providing a shaped article;
wherein the salt stress crack behavior of the blend composition when tested according to ASTM D1693 is characterized by standard test plaques that exhibit fewer cracks than comparison test plaques prepared from a similar composition that does not contain the ionomer when exposed to 50% aqueous calcium chloride solution at about 80° C. for at least 24 hours.

18. The method of claim 17 wherein reinforcing filler is blended in.

19. The method of claim 18 wherein the reinforcing filler comprises glass fiber.

20. The method of claim 17 wherein the shaped article comprising the composition exhibits improved retention of tensile strength and elongation when treated at 230° C. that is better than an article comprising a comparison composition comprising the polyamide that does not contain the ionomer with a mixture of zinc cations and sodium or lithium cations.

21. A shaped article comprising the composition of claim 1.

22. The article of claim 21 that exhibits salt stress crack behavior when tested according to ASTM D1693 that is better than an article comprising a comparison composition comprising the polyamide that does not contain the ionomer with a mixture of zinc cations and sodium or lithium cations.

23. The article of claim 21 wherein an article comprising the composition exhibits improved retention of tensile strength and elongation when treated at 230° C. that is better than an article comprising a comparison composition comprising the polyamide that does not contain the ionomer with a mixture of zinc cations and sodium or lithium cations.

24. The article of claim 20 wherein the reinforcing filler is present in the composition.

25. The article of claim 24 wherein the reinforcing filler comprises glass fiber.
